(19) United States
(12) Patent Application Publication
(10) Pub. No.: US 2011/0263738 A1
(43) Pub. Date: Oct. 27, 2011

(54) EXPANSION MOLDED BODY AND METHOD FOR PRODUCING EXPANSION MOLDED BODY

(75) Inventors: Yuya Yamamoto, Ichihara-shi (JP); Nobuhiro Usui, Ichihara-shi (JP); Kenji Atarashi, Kimitsu-shi (JP); Kenji Watanabe, Ichihara-shi (JP)

(73) Assignees: Kuraray Co., LTD., Okayama (JP); SUMITOMO CHEMICAL COMPANY, LIMITED, Chuo-ku (JP)

(21) Appl. No.: 13/141,613

(22) PCT Filed: Dec. 18, 2009
(86) PCT No.: PCT/JP2009/071153

§ 371 Date: Jun. 22, 2011

(30) Foreign Application Priority Data
Dec. 24, 2008 (JP) 2008-327872

(51) Int. Cl. C08L 29/04; B29C 69/02; C08J 9/35; C08L 23/26; C08L 23/12; B29C 45/00; C08L 23/02

(52) U.S. Cl. 521/134; 264/41

(57) ABSTRACT

A foamed article comprising a polyolefin resin composition (I) comprising a polyvinyl alcohol fiber (A), a polyolefin resin (B), and an unsaturated carboxylic acid-modified polyolefin resin and/or an unsaturated carboxylic acid derivative-modified polyolefin resin (C);
the polyvinyl alcohol fiber (A) being present in an amount of 1 to 70 mass %, the polyolefin resin (B) being present in an amount of 20 to 98.5 mass %, and the modified polyolefin resin (C) being present in an amount of 0.5 to 40 mass % with respect to the total amount of the polyvinyl alcohol fiber (A), the polyolefin resin (B), and the modified polyolefin resin (C);
the foamed article having an expansion ratio ranging from 1.3 to 5;
the polyvinyl alcohol fiber (A) comprising polyvinyl alcohol filaments (A-I) and a sizing agent (A-II), the sizing agent (A-II) being present in an amount of 0.1 to 10 parts by mass per 100 parts by mass of the polyvinyl alcohol filaments (A-I).

### TECHNICAL FIELD

The present invention relates to a foamed article of a polyolefin resin composition.

### BACKGROUND ART

As means for improving the mechanical properties and heat resistance of molded articles of a thermoplastic resin, the incorporation of a reinforcing fiber in the resin to be molded is widely employed. Injection foaming methods using blowing agents are also employed in order to reduce the weight of thermoplastic resin molded articles. Patent Literature 1, for example, discloses a fiber-reinforced, light-weight thermoplastic resin molded article produced from a fiber-containing thermoplastic resin by an injection foaming method using a chemical blowing agent.

### CITATION LIST

### Patent Literature

Patent Literature 1: Japanese Patent Laid-Open No. Hei-10-119079

### SUMMARY OF INVENTION

### Technical Problem

However, there has been a demand to further improve the impact resistance of such a conventional fiber-reinforced, light-weight thermoplastic resin molded article produced by an injection foaming method using a chemical blowing agent solely.

In view of the above-mentioned problem, an object of the present invention is to provide a foamed article having excellent impact resistance and a method for producing the same.

### Solution to Problem

The present invention relates to a foamed article comprising a polyolefin resin composition (I) comprising a polyvinyl alcohol fiber (A), a polyolefin resin (B), and an unsaturated carboxylic acid-modified polyolefin resin and/or an unsaturated carboxylic acid derivative-modified polyolefin resin (C);

the polyvinyl alcohol fiber (A) being present in an amount of 1 to 70 mass %, the polyolefin resin (B) being present in an amount of 20 to 98.5 mass %, and the modified polyolefin resin (C) being present in an amount of 0.5 to 40 mass % with respect to the total amount of the polyvinyl alcohol fiber (A), the polyolefin resin (B), and the modified polyolefin resin (C);

the foamed article having an expansion ratio ranging from 1.3 to 5,

the polyvinyl alcohol fiber (A) comprising polyvinyl alcohol filaments (A-I) and a sizing agent (A-II), the sizing agent (A-II) being present in an amount of 0.1 to 10 parts by mass per 100 parts by mass of the polyvinyl alcohol filaments (A-I).

The present invention also relates to a method for producing the foamed article comprising steps (1) to (6):

(1) melting the polyolefin resin composition (1) in a cylinder of an injection molding machine to produce a molten resin composition;

(2) feeding a physical blowing agent into the cylinder of the injection molding machine, and dissolving the physical blowing agent in the molten resin composition to produce a molten foamable resin composition;

(3) injecting, into a mold cavity formed by a pair of male and female molds, the molten foamable resin composition having a volume equal to or less than that of the cavity;

(4) foaming the injected foamable resin composition in the mold cavity;

(5) solidifying the foamed resin composition by cooling in the mold cavity to produce a foamed article; and

(6) removing the foamed article by opening both the molds.

### Advantageous Effects of Invention

According to the present invention, a foamed article having excellent impact resistance can be provided.

### DESCRIPTION OF EMBODIMENTS

The foamed article of the present invention is a foamed article made from a polyolefin resin composition (I).

[Polyolefin Resin Composition (I)]

The polyolefin resin composition (I) comprises a polyvinyl alcohol fiber (A), a polyolefin resin (B), and an unsaturated carboxylic acid-modified polyolefin resin and/or unsaturated carboxylic acid derivative-modified polyolefin resin (C). Each of these components will be described in detail below.

<Polyvinyl Alcohol Fiber (A)>

The polyvinyl alcohol fiber (A) of the present invention is a composite fiber obtained by applying the sizing agent (A-II) to the polyvinyl alcohol filaments (A-I).

The method for applying the sizing agent to the polyvinyl alcohol filaments (A-I) is not particularly limited. For example, a method may be used in which the filaments are soaked in a tank containing the sizing agent, and, after being nipped, the filaments are dried using a hot-air oven, a hot roller, or a hot plate.

The method for producing the polyvinyl alcohol filaments (A-I) is not particularly limited. For example, a method may be used in which a spinning solution prepared by dissolving a polyvinyl alcohol-based polymer in water or an organic solvent is formed into fibers by a wet spinning method or a dry spinning method, using a solidifying bath containing water or an organic solvent capable of solidifying the polyvinyl alcohol-based polymer. The wet spinning method is a method in which the spinning solution is discharged through a spinneret directly into the solidifying bath. The dry spinning method is a method in which the spinning solution is discharged first into air or an inert gas through a spinneret, and then introduced into the solidifying bath.

Although the structure of the polyvinyl alcohol-based polymer is not particularly limited, the polyvinyl alcohol-based polymer preferably has an average polymerization degree of 1,000 or more, more preferably 1,200 or more, preferably 5,000 or less, and particularly preferably 4,000 or less, in view of the mechanical properties, heat resistance, and so on of the polyvinyl alcohol filaments (A-I). For the same reason as above, the polyvinyl alcohol-based polymer preferably has a saponification degree of 99 mol % or more, and more preferably 99.8 mol % or more. The polyvinyl alcohol-based polymer that forms fibers may be, as well as a polyvinyl alcohol, any of the following: a polymer that produces a polyvinyl alcohol by a treatment such as hydrolysis; a product obtained by modifying a polyvinyl alcohol-based polymer with an acid such as a carboxylic acid and/or a derivative thereof; and a product obtained by copolymerization of a polyvinyl alcohol-based polymer and a polyvinyl alcohol-based polymer modified with an acid such as a carboxylic acid and/or a derivative thereof. The average polymerization degree and saponification degree of the polyvinyl alcohol-based polymer are the values measured in accordance with JIS K 6726.

Examples of the sizing agent (A-II) include the polyolefin resin (B) and the modified polyolefin resin (C) described below, polyurethane resins, polyester resins, acrylic resins, epoxy resins, starches, and vegetable oils. Among the above, the polyolefin resin (B), the modified polyolefin resin (C), polyurethane resins, epoxy resins, and so on are preferably used; the polyolefin resin (B) and the modified polyolefin resin (C) are more preferably used; and polypropylene resins and modified polypropylene resins are still more preferably used. An example of a modified polyolefin resin is an acid-modified polyolefin. These resins may be used alone or two or more of them may be used in combination.

The amount of the sizing agent (A-II) applied to the polyvinyl alcohol filaments (A-I) is 0.1 to 10 parts by mass, preferably 0.1 to 7 parts by mass, and more preferably 0.2 to 5 parts by mass of the sizing agent (A-II), per 100 parts by mass of the polyvinyl alcohol filaments (A-I).

The application of the sizing agent (A-II) in amounts of 0.1 parts by mass or more can impart sufficient binding properties, and can prevent entanglement of polyvinyl alcohol fibers during the manufacture of a resin composition in a pellet form using the pultrusion method described below. Furthermore, the application of the sizing agent (A-II) in amounts of 0.1 parts by mass or more can result in the formation of a foamed article having excellent strength during the molding of the resin composition. The application of the sizing agent (A-II) in amounts of 10 parts by mass or less can result in the formation of a foamed article having excellent strength.

A surface treating agent may be added to the sizing agent (A-II) in order to improve the adhesion properties, the wettability, and the like during the wetting of the polyvinyl alcohol filaments (A-I) with the modified polyolefin resin (C) described below. Examples of the surface treating agent include silane coupling agents, titanate coupling agents, aluminum coupling agents, chromium coupling agents, zirconium coupling agents, and borane coupling agents. Among the above, silane coupling agents and titanate coupling agents are preferable, and silane coupling agents are more preferable.

Examples of silane coupling agents include triethoxysilane, vinyl tris(β-methoxyethoxy)silane, γ-methacryloxypropyltrimethoxysilane, γ-glycidoxypropyltrimetoxysilane, β-(3,4-epoxycyclohexyl)ethyltrimethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, γ-mercaptopropyltrimethoxysilane, and γ-chloropropyltrimetoxysilane. Among the above, amino silanes such as γ-aminopropyltriethoxysilane and N-β-(aminoethyl)-γ-aminopropyltrimethoxysilane are preferably used.

The sizing agent (A-II) may also contain lubricants such as paraffin waxes, in addition to the surface treating agents mentioned above.

The amount of the polyvinyl alcohol fiber (A) in the polyolefin resin composition (I) is preferably 1 to 70 mass %, and more preferably 10 to 40 mass %, with respect to the total amount of the polyvinyl alcohol fiber (A), the polyolefin resin (B), and the modified polyolefin resin (C) in view of the mechanical strength of the foamed article, such as the rigidity and impact strength, as well as the production stability of the polyolefin resin composition (I).

<Polyolefin Resin (B)>

The polyolefin resin (B) in the polyolefin resin composition (I) is a resin made of a homopolymer of an olefin or a copolymer of two or more olefins. That is, the polyolefin resin (B) is a polyolefin resin other than the modified polyolefin resin (C) modified by an unsaturated carboxylic and/or an unsaturated carboxylic acid derivative. Specific examples of the polyolefin resin (B) include polyethylene resins and polypropylene resins. Polypropylene resins are preferable as the polyolefin resin. A single resin or a combination of two or more resins may be used as the polyolefin resin (B).

Examples of polyethylene resins include ethylene homopolymers, ethylene-propylene random copolymers, and ethylene-α-olefin random copolymers.

Examples of polypropylene resins include propylene homopolymers, propylene-ethylene random copolymers, propylene-α-olefin random copolymers, propylene-ethylene-α-olefin random copolymers, and propylene-based block copolymers obtained by homopolymerization of propylene, which is followed by copolymerization of ethylene and propylene. In view of the heat resistance of the foamed article, it is preferable to use, as the polypropylene resin, a propylene homopolymer or a propylene-based block copolymer obtained by homopolymerization of propylene, which is followed by copolymerization of ethylene and propylene.

The amount of the structural units derived from ethylene in the propylene-ethylene random copolymer (the total amount of propylene and ethylene is 100 mol %), the amount of the structural units derived from the α-olefin in the propylene-α-olefin random copolymer (the total amount of propylene and the α-olefin is 100 mol %), and the total amount of the structural units derived from ethylene and the structural units derived from the α-olefin in the propylene-ethylene-α-olefin random copolymer (the total amount of propylene, ethylene, and the α-olefin is 100 mol %) are all preferably less than 50 mol %.

The amount of the structural units derived from ethylene, the amount of the structural units derived from the α-olefin, and the total amount of the structural units derived from ethylene and the structural units derived from the α-olefin are the values measured using the IR or NMR method described in Shinpan Kobunshi Bunseki Handbook (“New Edition of the Handbook for Polymer Analysis”), edited by the Research Committee for Polymer Analysis of the Japan Society of Chemistry, Books Kinokuniya (1995)).

The amount of the structural units derived from propylene in the ethylene-propylene random copolymer (the total amount of the structural units derived from ethylene and the structural units derived from propylene is 100 mol %), the amount of the structural units derived from the α-olefin in the ethylene-α-olefin random copolymer (the total amount of the structural units derived from ethylene and the structural units derived from the α-olefin is 100 mol %), and the total amount of the structural units derived from propylene and the structural units derived from the α-olefin in the ethylene-propylene-α-olefin random copolymer (the total amount of the structural units derived from ethylene and the structural units derived from propylene and the α-olefin is 100 mol %) are all less than 50 mol %.

Examples of α-olefins that form the polyolefin resin (B) include 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene, and 1-dodecen. Preferable are α-olefins with 4 to 8 carbon atoms (for example, 1-butene, 1-pentene, 1-hexene, and 1-octene).

The polyolefin resin (B) can be produced by a solution polymerization method, a slurry polymerization method, a bulk polymerization method, a vapor-phase polymerization method, or the like. These polymerization methods may be used alone or two or more of them may be used in combination.

More specific examples of methods for producing the polyolefin resin (B) include the polymerization methods described in “Shin Polymer Seizou Process” (“New Polymer Production Processes”) (edited by Yasuharu SAEKI, Kogyo Chosakai Publishing, Inc. (published in 1994)), Japanese Patent Laid-Open No. Hei-4-323207, Japanese Patent Laid-Open No. 61-287917, and so on. Examples of catalysts used for producing the polyolefin resin (B) include multi-site catalysts and single-site catalysts. Examples of preferable multi-site catalysts include catalysts obtained using solid catalyst components containing titanium, magnesium, and halogen atoms; and examples of preferable single-site catalysts include metallocene catalysts.

Preferable as the catalyst for use in producing the polypropylene resin as the polyolefin resin (B) are the above-mentioned catalysts obtained using solid catalyst components containing titanium, magnesium, and halogen atoms.

The polyolefin resin (B) has a melt flow rate (MFR) of preferably 1 to 500 g/10 min, more preferably 10 to 400 g/10 min, still more preferably 20 to 300 g/10 min, and even more preferably 50 to 200 g/10 min in order to prevent deterioration of the dispersibility of the polyvinyl alcohol fiber (A) in the polyolefin resin composition (I), prevent the resulting skin material layer from being poor in appearance, and prevent deterioration of the impact strength. The MFR is a value measured at 230° C. and a load of 21.2 N in accordance with ASTM D1238.

The propylene homopolymer used as the polyolefin resin (B) has an isotactic pentad fraction of preferably 0.95 to 1.0, more preferably 0.96 to 1.0, and still more preferably 0.97 to 1.0. The isotactic pentad fraction is measured by the method disclosed by A. Zambelli et al. in Macromolecules, vol. 6, p. 925 (1973); namely, it represents a fraction of propylene monomer units present at the center of an isotactic chain in the form of a pentad unit in the propylene molecular chain, i.e., a fraction of propylene monomer units at the center of a chain in which five propylene monomer units are successively meso-bonded in the propylene molecular chain, as measured using 13C-NMR. The assignment of NMR absorption peaks is based on Macromolecules, vol. 6, p. 925 (1973).

When the polyolefin resin (B) used in the present invention is a propylene block copolymer obtained by homopolymerization of propylene, which is followed by copolymerization of ethylene and propylene, the propylene homopolymer portion has an isotactic pentad fraction of preferably 0.95 to 1.0, more preferably 0.96 to 1.0, and still more preferably 0.97 to 1.0.

The amount of the polyolefin resin (B) in the polyolefin resin composition (I) is preferably 20 to 98.5 mass %, and more preferably 50 to 89 mass % with respect to the total amount of the polyvinyl alcohol fiber (A), the polyolefin resin (B), and the modified polyolefin resin (C) in view of the mechanical strength of the resulting skin material layer, such as the rigidity and impact strength, as well as the production stability of the polyolefin resin composition (I). When the amount of the polyolefin resin (B) is within the above-defined range, a foamed article having sufficient rigidity and impact strength can be formed.

<Unsaturated Carboxylic Acid-Modified Polyolefin Resin and/or Unsaturated Carboxylic Acid Derivative-Modified Polyolefin Resin (C)>

As mentioned above, the polyolefin resin composition (I) comprises the unsaturated carboxylic acid-modified polyolefin resin and/or unsaturated carboxylic acid derivative-modified polyolefin resin (C).

The polyolefin resin used as a starting material of the modified polyolefin resin (C) is a resin made of a homopolymer of a single olefin or a copolymer of two or more olefins. In other words, the modified polyolefin resin (C) is a resin that is produced by making a homopolymer of a single olefin or a copolymer of two or more olefins react with an unsaturated carboxylic acid and/or an unsaturated carboxylic acid derivative, and has in its molecule a partial structure derived from the unsaturated carboxylic acid or the unsaturated carboxylic acid derivative. Specific examples of the modified polyolefin resin (C) include modified polyolefin resins (C-a) to (C-c) given below. These resins may be used alone or two or more resins may be used in combination.

(C-a): A modified polyolefin resin obtained by graft polymerization of an unsaturated carboxylic acid and/or an unsaturated carboxylic acid derivative to a homopolymer of an olefin.

(C-b): A modified polyolefin resin obtained by graft polymerization of an unsaturated carboxylic acid and/or an unsaturated carboxylic acid derivative to a copolymer obtained by copolymerization of two or more olefins.

(C-c): A modified polyolefin resin obtained by graft polymerization of an unsaturated carboxylic acid and/or an unsaturated carboxylic acid derivative to a block copolymer obtained by homopolymerization of an olefin, which is followed by copolymerization of two or more olefins.

Examples of the unsaturated carboxylic acid include unsaturated carboxylic acids with 3 or more carbon atoms, such as maleic acid, fumaric acid, itaconic acid, acrylic acid, and methacrylic acid.

Examples of the unsaturated carboxylic acid derivative include acid anhydrides, ester compounds, amide compounds, imide compounds, metal salts, and so on of unsaturated carboxylic acids. Specific examples of the unsaturated carboxylic acid derivative include maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, 2-hydroxyethyl methacrylate, monoethyl maleate, diethyl maleate, monomethyl fumarate, dimethyl fumarate, acrylamide, methacrylamide, maleic monoamide, maleic diamide, fumaric monoamide, maleimide, N-butylmaleimide, and sodium methacrylate.

Among the above, maleic acid and acrylic acid are preferably used as the unsaturated carboxylic acid; and glycidyl methacrylate, maleic anhydride, and 2-hydroxyethyl methacrylate are preferably used as the unsaturated carboxylic acid derivative.

Preferable as the modified polyolefin resin (C) are the resins (C-c). Among the resins (C-c), it is more preferable to use the following resin (C-d):

(C-d) a modified polyolefin resin obtained by graft polymerization of maleic anhydride, glycidyl methacrylate, or 2-hydroxyethyl methacrylate to a polyolefin resin containing units derived from olefin(s) that are ethylene and/or propylene as principal structural units.

The amount of the structural units derived from the unsaturated carboxylic acid and/or the unsaturated carboxylic acid derivative in the modified polyolefin resin (C) is preferably 0.1 to 10 mass %, more preferably 0.1 to 5 mass %, still more preferably 0.2 to 2 mass %, and particularly preferably 0.4 to 1 mass % in order to improve the impact strength, fatigue properties, rigidity, and so on of the skin material layer. The amount of the structural units derived from the unsaturated carboxylic acid and/or the unsaturated carboxylic acid derivative is the value obtained by quantifying the absorption by at least one compound selected from the group consisting of unsaturated carboxylic acids and unsaturated carboxylic acid derivatives, using an infrared absorption spectrum or NMR spectrum.

These modified polyolefin resins (C) can be produced by a solution method, a bulk method, a melt compounding method, or the like. Two or more of these methods may also be used in combination.

Specific examples of the solution method, the bulk method, the melt compounding method, and so on include the methods described in “Jitsuyo Polymer Alloy Sekkei” (“Practical Design of Polymer Alloys”) (written by Fumio IDE, Kogyo Chosakai Publishing, Inc. (published in 1996)), Prog. Polym. Sci., 24, 81-142 (1999), Japanese Patent Laid-Open No. 2002-308947, Japanese Patent Laid-Open No. 2004-292581, Japanese Patent Laid-Open No. 2004-217753, Japanese Patent Laid-Open No. 2004-217754, and so on.

A commercially available modified polyolefin resin may be used as the modified polyolefin resin (C). Examples of commercially available modified polyolefin resins include trade name: Modiper (manufactured by NOF Corporation); trade name: Blemmer CP (manufactured by NOF Corporation); trade name: Bondfast (manufactured by Sumitomo Chemical Co., Ltd.); trade name: Bondine (manufactured by Sumitomo Chemical Co., Ltd.); trade name: Rexpearl (manufactured by Japan Polyethylene Corporation); trade name: Admer (manufactured by Mitsui Chemicals, Inc.); trade name: Modic-AP (manufactured by Mitsubishi Chemical Corporation); trade name: Polybond (manufactured by Crompton Corporation); and trade name: Umex (Sanyo Chemical Industries, Ltd.).

The amount of the modified polyolefin resin (C) in the polyolefin resin composition (I) is preferably 0.5 to 40 mass %, and more preferably 0.5 to 20 mass % with respect to the total amount of the polyvinyl alcohol fiber (A), the polyolefin resin (B), and the modified polyolefin resin (C) in view of the mechanical strength of the foamed article, such as the rigidity and impact strength, as well as the production stability of the polyolefin resin composition (I).

When the amount of the modified polyolefin resin (C) is within the above-defined range, sufficient rigidity and impact strength can be provided.

Examples of methods for producing the polyolefin resin composition (I) include the following methods (1a) to (3a):

(1a) a method in which all of the components are mixed to form a mixture, and the mixture is subsequently melt kneaded;

(2a) a method in which components are combined as desired, and the combinations are individually mixed to form mixtures, which are then melt kneaded; and

(3a) pultrusion.

In the method (1a) or (2a) above, the mixture or mixtures can be prepared by, for example, a method in which the components are mixed in a blender, such as a Henschel mixer or a ribbon blender.

Melt compounding can be performed by, for example, a method using a Banbury mixer, a Plastomill, a Brabender, a Plastograph, a single- or twin-screw extruder, or the like.

Among the methods (1a) to (3a) above, the method (3a) is preferably used in view of its ease of manufacture and the mechanical strength of the resulting skin material layer. Pultrusion, in principal, is a method in which a continuous bundle of fibers is impregnated with a resin while it is pulled. Examples of pultrusion include the following methods (3a-1) to (3a-3).

(3a-1) A method in which a bundle of fibers is passed through an impregnation tank containing an emulsion, suspension, or solution of a resin and a solvent, whereby the bundle of the fibers is impregnated with the emulsion, suspension, or solution, and the solvent is subsequently removed.

(3a-2) A method in which a bundle of fibers is sprayed with a resin powder, or passed through a tank containing a resin powder, whereby the resin powder is adhered to the fibers, and the powder is subsequently melted, so that the bundle of the fibers is impregnated with the resin.

(3a-3) A method in which a molten resin is fed to a crosshead from an extruder or the like while a bundle of fibers is passed through the crosshead, whereby the bundle of the fibers is impregnated with the resin.

Among these methods, the pultrusion method (3a-3) using a crosshead is preferably used. More preferably, a pultrusion method using a crosshead such as that disclosed in Japanese Patent Laid-Open No. Hei-3-272830 is used.

In the above-mentioned pultrusion methods, the operation of resin impregnation may be performed in one stage or two or more stages. Moreover, pellets produced by any of the pultrusion methods may be blended with pellets produced by the melt compounding method.

The polyvinyl alcohol fiber (A) in the polyolefin resin composition (I) obtained by any of the above-mentioned methods has a weight average fiber length of preferably 2 to 50 mm, more preferably 3 to 20 mm, and particularly preferably 5 to 15 mm in view of the mechanical strength of the foamed article, such as the rigidity and impact strength, as well as the ease of manufacture of the resin composition.

The weight average fiber length of the polyvinyl alcohol fiber (A) is equal to the average length of the polyvinyl alcohol filaments (A-I) contained in one pellet of the polyolefin resin composition (I). The weight average fiber length of the polyvinyl alcohol filaments (A-I) is the value measured as follows: the polyvinyl alcohol filaments (A-I) are separated from the polyvinyl alcohol fiber (A) in a pellet form, using a known technique such as solvent extraction; subsequently, the length of each one of the separated polyvinyl alcohol filaments (A-I) is measured by the method disclosed in Japanese Patent Laid-Open No. 2002-5924 (excluding the ashing step), and the average of the measured values is calculated.

The polyolefin resin composition (I) may optionally contain one or more than one elastomer. Examples of elastomers include polyester-based elastomers, polyurethane-based elastomers, PVC-based elastomers, and mixtures thereof.

Furthermore, the polyolefin resin composition (I) may optionally contain known materials added to general polyolefin resins; for example, stabilizers, such as antioxidants, heat stabilizers, neutralizers, and UV absorbents; antifoaming agents, flame retardants, flame retardant aids, dispersants, antistatic agents, lubricants, and anti-blocking agents, such as silica; coloring agents, such as dyes and pigments; plasticizers; nucleating agents; and crystallization accelerators. The polyolefin resin composition (I) may further contain inorganic compounds in a plate or powder form, such as glass flakes, mica, glass powders, glass beads, talc, clay, alumina, carbon black, and wollastonite; and whiskers.

[Method for Producing Foamed Article]

Injection foaming is employed when producing a foamed article from the above-described polyolefin resin composition (I). An example of an injection foaming method includes the following steps (1) to (6):

(1) melting the polyolefin resin composition (1) in a cylinder of an injection molding machine to produce a molten resin composition;

(2) feeding a physical blowing agent into the cylinder of the injection molding machine, and dissolving the physical blowing agent in the molten resin composition to produce a molten foamable resin composition;

(3) injecting, into a mold cavity formed by a pair of male and female molds, the molten foamable resin composition having a volume equal to or less than that of the cavity;

(4) foaming the injected foamable resin composition in the mold cavity;

(5) solidifying the foamed resin composition by cooling in the mold cavity to produce a foamed article; and

(6) removing the foamed article by opening both the molds.

In the injection foaming method, examples of methods for melting the physical blowing agent into the molten resin composition include a method in which a physical blowing agent in a gaseous or supercritical state as described below is injected into the resin composition melted in the cylinder; and a method in which a physical blowing agent in a liquid state is injected with a plunger pump or the like.

In the injection foaming, the method for foaming the molten foamable resin composition is not particularly limited. Examples of the foaming method include a method like so-called core-back molding, in which the surface of the cavity wall is retracted to enlarge the cavity volume, thereby expanding the gas derived from the blowing agent, and foaming the molten resin composition filled within the cavity.

Preferably, the molten foamable resin composition is injected into the cavity in an amount such that the entire cavity is filled with the molten foamable resin composition at the point of time immediately after the injection has completed.

Examples of injection methods in the injection foaming include single-screw injection, multi-screw injection, high-pressure injection, low-pressure injection, and injection using a plunger.

The injection foaming may be performed in combination with a molding method such as gas-assist molding, melt-core molding, insert molding, core-back molding, or two-color molding.

The thermoplastic resin foamed article of the present invention may have any desired shape.

The temperature during the injection foaming is such that the cylinder temperature of the injection molding machine is 170 to 250° C., preferably 180 to 220° C., and more preferably 180 to 200° C., and the cavity temperature is 0 to 100° C., preferably 5 to 60° C., and more preferably 20 to 50° C.

The back pressure during molding is 1 to 30 MPa, preferably 5 to 20 MPa, and more preferably 6 to 15 MPa. When the back pressure is within this range, the molten foamable resin composition can dissolve the blowing agent without foaming in the cylinder.

As stated above, a physical blowing agent is preferably used as the blowing agent for producing the foamed article of the present invention.

Examples of physical blowing agents include inert gases such as nitrogen and carbon dioxide; and volatile organic compounds such as butane and pentane. Two or more physical blowing agents can be used in combination.

The blowing agent used in the present invention is preferably an inert gas. The inert gas is preferably an inorganic substance that is gaseous at normal temperature and pressure, and is not reactive with the polyolefin resin composition to be foamed, and hence, is free of the possibility of causing the resin to deteriorate. Examples of inert gases include carbon dioxide, nitrogen, argon, neon, helium, and oxygen. Carbon dioxide, nitrogen, and a mixture thereof are preferably used in view of their inexpensive costs and safety. An inert gas in a supercritical state is more preferably used as the blowing agent in view of its solubility and diffusibility in the polyolefin resin composition.

The amount of the blowing agent per 100 parts by mass of the polyolefin resin composition (I) is 0.3 to 10 parts by mass, preferably 0.6 to 5 parts by mass, and more preferably 0.6 to 4 parts by mass.

A chemical blowing agent may also be added to the blowing agent. Examples of usable chemical blowing agents include inorganic and organic chemical blowing agents.

Examples of inorganic chemical blowing agents include hydrogencarbonates such as sodium hydrogencarbonate; and ammonium carbonate.

Examples of organic chemical blowing agents include polycarboxylic acids, azo compounds, sulfone hydrazide compounds, nitroso compounds, p-toluenesulfonyl semicarbazide, and isocyanate compounds.

Examples of polycarboxylic acids include citric acid, oxalic acid, fumaric acid, and phthalic acid.

The expansion ratio of the foamed article of the present invention, which is determined by dividing the density of the polyolefin resin composition (I) by the density of the foamed article, is 1.3 to 5. The expansion ratio is preferably 1.5 to 3.5.

The polyvinyl alcohol fiber (A) contained in the foamed article of the present invention has a weight average fiber length of 2 to 50 mm, preferably 5 to 20 mm, and more preferably 5 to 12 mm.

### Examples

The present invention will be described in greater detail below, referring to the following Examples; however, the invention is not limited to these Examples.

In the Example or Comparative Examples, the following materials were used.

Polyvinyl Alcohol Fiber (A):

A polyvinyl alcohol fiber obtained by applying 5 parts by mass of an emulsion of a carboxylic acid-modified polypropylene (A-II) (trade name “HYTEC P-6000”, manufactured by Toho Chemical Industry, Co., Ltd.) to 100 parts by mass of polyvinyl alcohol filaments (A-I) (Vmylon (registered trademark) 5501-2, manufactured by Kuraray Co., Ltd., filament diameter: 14 μm).

Modified Polyolefin Resin (C):

A maleic anhydride-modified polypropylene prepared according to the method described in Example 1 of Japanese Patent Laid-Open No. 2004-197068.

MFR: 60 g/10 min

The amount of the grafted maleic anhydride: 0.6 mass %

Polyolefin Resin (B-1):

A propylene homopolymer, manufactured by Sumitomo Chemical Co., Ltd., trade name: “Noblen U501E1”.

MFR: 120 g/10 min

Polyolefin Resin (B-2):

An ethylene-propylene block copolymer, manufactured by Sumitomo Chemical Co., Ltd., trade name: “Noblen AU891E2”.

MFR: 80 g/10 min

Continuous Glass Fiber-Reinforced Polypropylene Resin Composition (D):

Pellets of a continuous glass fiber-reinforced polypropylene resin (9 mm long) were prepared according to the method described in Example 1 of Japanese Patent Laid-Open No. Hei-3-121146, using a composition containing 2.5 mass % of the above-mentioned maleic anhydride-modified polypropylene resin (C); 50 mass % of a glass fiber (fiber diameter: 17 μm); 47 mass % of an unmodified propylene homopolymer (MFR: 100 g/10 min); 0.3 mass % of a sulfur-based antioxidant (trade name “Sumilizer TPM”, manufactured by Sumitomo Chemical Co., Ltd.); 0.1 mass % of a phenolic antioxidant (trade name “Irganox 1010”, manufactured by Ciba Japan K.K.); and 0.1 mass % of a phenolic antioxidant (trade name “Irganox 1330”, manufactured by Ciba Japan K.K.). The impregnation temperature was 270° C., and the take-off speed was 13 m/min. This continuous glass fiber-reinforced polypropylene resin is denoted as the “continuous glass fiber-reinforced polypropylene resin composition (D)”.

[Methods for Measuring Physical Properties]

(1) Melt Flow Rate (MFR)

The melt flow rate was measured at a temperature of 230° C. and a load of 21.2 N in accordance with JIS K7210.

(2) Density

The specific gravity of a molded article was measured using a densimeter (Electronic Densimeter EW-200SG, manufactured by Mirage Trading Co., Ltd.), and the density of the molded article was determined according to the following equation:

(density of molded article)=(specific gravity of molded article)×(density of pure water),

wherein the density of the pure water is 1.0 g/cm³.

(3) Expansion Ratio

The expansion ratio of a foamed article was determined by dividing the density of the resin composition forming the foamed article by the density of the foamed article.

(4) Impact Resistance Value

The impact value of a foamed article was measured using the high rate impact tester (manufactured by Reometrics, Inc.) as follows: the sample fixed with a ring having an inner diameter of 3 inches was punched with a dart having a diameter of ½ inch at a punching speed of 5 m/sec, and the load with respect to the sample displacement was measured. The energy value required for punching was subsequently calculated, and the calculated value was determined as the “impact resistance value”.

### Example 1

A foamed article and a slightly foamed article for evaluation were produced by the methods described below.

Pellets (I) of a polyvinyl alcohol fiber-containing polyolefin resin composition (9 mm long) were prepared using the composition shown in Table 1, according to the method described in Example 1 of Japanese Patent Laid-Open No. Hei-3-121146.

### <Foamed Article>

Injection foaming was performed using the pellets (I) and a molding apparatus including a mold having a box-shaped cavity 290 mm wide, 370 mm long, 45 mm high, and 1.5 mm thick in outer dimensions (gate structure: valve gate, gate position: central portion of the molded article); and an injection molding machine equipped with the mold (ES2550/400HL-MuCell, manufactured by Engel; mold clamping force: 400 tons). Nitrogen gas for use as the physical blowing agent was fed at a pressure of 10 MPa into the cylinder of the injection molding machine (the amount of the blowing agent injected: 0.9 parts by mass per 100 parts by mass of the pellets (I)). A molten product of the continuous glass fiber-reinforced polypropylene resin (D) was injected at a cylinder temperature of 200° C. and a mold temperature of 50° C. in the injection molding machine, so as to completely fill the mold cavity. After a lapse of 4 seconds from the completion of the injection, the surface of the cavity wall (290 mm wide and 370 mm long) was retracted 2 mm to increase the inner volume of the cavity, thereby foaming the molten product. The foamed molten product was subsequently solidified by cooling, thus yielding a foamed article.

### <Microcellular Foamed Article>

Injection foaming was performed using the pellets (I) and the same molding apparatus as that used in the production of the foamed article described above. A molten product of the continuous glass fiber-reinforced polypropylene resin (D) was injected at a cylinder temperature of 200° C. and a mold temperature of 50° C. in the injection molding machine, so as to completely fill the mold cavity. The molten product was foamed without forcibly retracting the surface of the cavity wall of the mold, and the foamed molten product was subsequently solidified by cooling, thus yielding a slightly foamed article.

The foamed article and the slightly foamed article were evaluated. The results are shown in Table 1. The foamed article of the present invention had an impact resistance value higher than that of the slightly foamed article.

### Comparative Example 1

A foamed article and a slightly foamed article were produced by the same methods as described in Example 1, except that pellets of the continuous glass fiber-reinforced polypropylene (D) were used instead of the pellets (I), and evaluations were conducted. The results are shown in Table 1. The foamed article had an impact resistance value lower than that of the slightly foamed article.

### Comparative Example 2

A foamed article and a slightly foamed article were produced by the same methods as described in Example 1, except that pellets of the polyolefin resin (B-2) were used instead of the pellets (I), and evaluations were conducted. The results are shown in Table 1. The foamed article had an impact resistance value lower than that of the slightly foamed article.

TABLE 1

| | | | | Com. | Com. |
|---|---|---|---|---|---|
| | | | Ex. 1 | Ex. 1 | Ex. 2 |
| Compo- | A | | 15 | 0 | 0 |
| nents | B-1 | | 81 | 0 | 0 |
| | B-2 | | 0 | 0 | 100 |
| | C | | 4 | 0 | 0 |
| | D | | 0 | 100 | 0 |
| Evalu- | Foamed | Density | 0.39 | 0.43 | 0.36 |
| ation | Article | Expansion Ratio | 2.44 | 2.58 | 2.50 |
| | | Impact Resistance | 1.9 | 2.2 | 5.7 |
| | | Value | | | |
| | Slightly | Density | 0.90 | 1.04 | 0.87 |
| | Foamed | Expansion Ratio | 1.06 | 1.07 | 1.03 |
| | Article | Impact Resistance | 1.2 | 3.5 | 8.0 |
| | | Value | | | |

| | | | |
|---|---|---|---|
| Ratio of Impact Resistance Values | 1.6 | 0.6 | 0.7 |

1. A foamed article comprising a polyolefin resin composition (I) comprising a polyvinyl alcohol fiber (A), a polyolefin resin (B), and an unsaturated carboxylic acid-modified polyolefin resin and/or an unsaturated carboxylic acid derivative-modified polyolefin resin (C);
the polyvinyl alcohol fiber (A) being present in an amount of 1 to 70 mass %, the polyolefin resin (B) being present in an amount of 20 to 98.5 mass %, and the modified polyolefin resin (C) being present in an amount of 0.5 to 40 mass % with respect to the total amount of the polyvinyl alcohol fiber (A), the polyolefin resin (B), and the modified polyolefin resin (C);
the foamed article having an expansion ratio ranging from 1.3 to 5;
the polyvinyl alcohol fiber (A) comprising polyvinyl alcohol filaments (A-I) and a sizing agent (A-II), the sizing agent (A-II) being present in an amount of 0.1 to 10 parts by mass per 100 parts by mass of the polyvinyl alcohol filaments (A-I).

2. The foamed article according to claim 1, wherein the sizing agent (A-II) is a polypropylene resin and/or a modified polypropylene resin.

3. The foamed article according to claim 1, wherein the polyvinyl alcohol fiber (A) has a fiber length of 2 to 50 mm.

4. The foamed article according to claim 2, wherein the polyvinyl alcohol fiber (A) has a fiber length of 2 to 50 mm.

5. A method for producing the foamed article of claim 1, comprising steps (1) to (6):
(1) melting the polyolefin resin composition (1) in a cylinder of an injection molding machine to produce a molten resin composition;
(2) feeding a physical blowing agent into the cylinder of the injection molding machine, and dissolving the physical blowing agent in the molten resin composition to produce a molten foamable resin composition;
(3) injecting, into a mold cavity formed by a pair of male and female molds, the molten foamable resin composition having a volume equal to or less than that of the cavity;
(4) foaming the injected foamable resin composition in the mold cavity;
(5) solidifying the foamed resin composition by cooling in the mold cavity to produce a foamed article; and
(6) removing the foamed article by opening both the molds.
